(19) United States
(12) Patent Application Publication
(10) Pub. No.: US 2004/0153326 A1
(43) Pub. Date: Aug. 5, 2004

(54) METHOD FOR TRAINING SERVICE PROVIDERS

(75) Inventor: Aart Van 't Land, Rilland (NL)

Correspondence Address: TRACY W. DRUCE, ESQ., 1496 EVANS FARM DR, MCLEAN, VA, 22101, US

(73) Assignee: LELY ENTERPRISES AG

(21) Appl. No.: 10/248,593

(22) Filed: Jan. 30, 2003

(51) Int. Cl. G06F 17/60

(52) U.S. Cl. 705/1

(57) ABSTRACT

A service network including a service provider, technical installations and users, at least some of the users being trained to carry out different service actions on the technical installations. The service network is adapted to store data for each user concerning the particular service actions which that user is trained to carry out; the level of competence which that user has in carrying out the service actions and the geographical location of each user and/or technical installation. In response to a service action request from a requesting user or technical installation, the service network determines the geographically closest user having the required level of competence to carry out the requested service action and issues an authorization. The service network and method are particularly well adapted to the provision of service to automatic milking robots.

### BACKGROUND OF INVENTION

1. Field of the Invention

The invention relates generally to a method of improving the service of serviced items, in particular of complex installations and more particularly to a method of maintaining such installations. It is particularly adapted to the maintenance of automatic milking robots whereby an adequate level of essential service is maintained and undue animal suffering is minimized.

2. Description of the Related Art

In the ever more sophisticated world in which we live, many devices and components have become so complex that it is no longer possible for unskilled individuals or persons without specialist knowledge and tools to maintain them. For example, in the past it was customary for many enthusiasts to maintain their own motorcars. Today however, vehicles increasingly use complex components especially electronic systems, which are only intended for servicing by authorized service agents having the requisite knowledge and equipment. It is frequent in such cases, that warranties on the vehicle or its components are invalid if non-authorized personnel have serviced or ‘tampered with’ the components in question. Manufacturers frequently use seals and tamper evident closures to indicate unauthorized access. It is also frequent for manufacturers and suppliers to use service books or records to ensure compliance with a requisite service schedule. Without compliance, the warranty may be compromised or invalid or the resale value of the service item may be significantly reduced. In order to meet the demands and requirements of customers in this respect to the cost of such specialist service and maintenance it has become common for service providers to provide service or maintenance contracts which guarantee a certain level of service in return for a fixed or substantially fixed sum.

In the case of a domestic heating installation for example, an authorized service provider may, upon payment of a fixed fee, provide an annual service overhaul and undertake to deliver 24-hour breakdown cover in the event of malfunction.

For mass-produced products such as motorcars and domestic central-heating systems, their widespread use makes the provision of such service relatively predictable. Statistically, the large population ensures that the variations in risk between different items largely cancels itself out, while the nature of mass-produced items also ensures a level of consistency in terms of failure rate.

It is also a feature of such mass-produced items that they are usually geographically well distributed. As such, a service provider may be able to provide service to a large number of customers within a given geographical area, cutting down travel time as a percentage of the total cost of providing service. In such circumstances, increased competition between service providers can lead to greater efficiency and ensure fast and effective service for the customer.

In the case of more complex and less widespread systems, the problems of providing a service contract are greater. The increased variability in breakdown or service characteristics and the greater geographical distribution of the systems require that the service provider must charge a higher price for service contacts in order to cover all risks or must revert to charging for service at an hourly rate or on an actual cost basis, thereby shifting the burden of the risk to the customer or owner of the system. Frequently, a mixture of systems is assumed, whereby a service provider may provide a first level of service for a basic fixed rate, and whereby for service beyond that limit a further fee is charged, e.g. 4 call-outs free per year. Alternatively, a service provider may assume a first level of service on an actual cost basis and may assume responsibility for all further service requirements under guarantee.

As is clear from the above, the provision of service contracts is an activity which is subject to a considerable degree of risk. This risk is related to the variability in the breakdown or service characteristics of the item or system requiring service but may also depend on other factors. The risk is further multiplied by the geographical distribution of the systems and also by the level of urgency involved. Clearly, the variation of risk associated with providing service to a refrigerated long-distance truck is greater than that of an office air conditioning system. While the provision and assessment of such service contracts may be seen as a purely economic activity, there are also other important considerations and consequences.

In general, the provision of satisfactory service is a basic requirement for ensuring safe reliable and efficient operation of the serviced item over an extended life. If the conditions under which this service is provided are not optimal, then there will be a tendency to avoid participating, to the detriment of the condition of the serviced item. This of course can lead to greater problems later on.

In the case of an essential item such as a milking robot, any breakdown must be avoided at all costs. A milking robot such as the Astronaut™ as manufactured by Lely Industries N.V. is an automatic milking machine which can provide the daily milking requirements for up to about 60 cows without any human intervention. Traditional milking parlours generally include a number of individual milking stations e.g. 12 allowing the cows to come in in batches for their morning and evening milking under the supervision of the herdsman. Faults arising in a single milking station will not usually prevent the milking from proceeding at the other stations. The Astronaut™ milking robot however has only a single milking station through which the cows may pass throughout the day, as and when they please. It is thus subject to an almost constant stream of traffic and any breakdown must be quickly remedied to avoid severe disruption and discomfort for the animals.

It is also a characteristic of farms that they are often located in rural and relatively inaccessible areas. Provision of emergency service for such milking robots must thus overcome the additional cost and time constraints of distant call-outs to ensure the well-being of the animals.

Thus, there is a particular need for an adequate form of service which is efficient in terms of time and cost and which maximizes the lifetime, reliability and efficiency of the serviced item.

### SUMMARY OF INVENTION

The present invention addresses these problems by providing a method of service which effectively integrates in a seamless manner the service provided by a user of the system and that provided by a supplier of the system. This method can be formalized in terms of a service contract.

According to a first aspect of the present invention a method of providing service for a serviced item is disclosed, comprising the steps of: identifying a group of first service actions; identifying a group of second service actions; instructing a user to recognize the need for first service actions; instructing the user to recognize the need for and perform second service actions and authorizing a user to perform a service action only if the service action falls in the group of second service actions.

Advantageously, the users may be required to report all service actions falling into either the first group or the second group whereby the service provider may update e.g. the second group of service actions on the basis of feedback from the user. This updating may take the form of adding further frequently occurring actions to the second group and may be combined with further training or instruction of the users in performing the additional actions. It may also take the form of adding further actions to the second group on the basis of a level of competence achieved by the user in performing the existing second service actions. It may also take the form of removing actions from the second group on the basis of a lack of competence of the user in performing the existing second service actions or on the basis of non-performance of such actions during a given period.

The method may involve identifying different respective first and second service actions for different users or even for different serviced items.

According to a preferred further embodiment the users, in providing feedback of the need for or the performance of service actions, ensure that the service provider is kept up to date with the state of service of the serviced items. This allows the service provider to maintain records of the most frequently occurring service actions and also determine which actions are the most problematic in terms of down time and repair costs. This may permit the service provider to more effectively focus development resources on overcoming the most urgent problems.

Another aspect of the present invention comprises a method of reducing the cost of service of a serviced item. The method may comprise providing a service contract between a service provider and a user of the serviced item, and covering at least a first group of service actions, identifying a second group of service actions, instructing the user to recognize and perform service actions from the second group of service actions and authorizing the user to perform a service action only if the service action falls in the second group of service actions.

According to a further aspect of the invention there is provided a service network comprising a service provider, a plurality of installations and a plurality of users, at least some of the users being trained to carry out different service actions on the installations. The service network may comprise action data storage means for storing data for each user concerning the particular service actions which that user is trained to carry out, competence data storage means for storing data for each user concerning the level of competence which that user has in carrying out the service actions, geographical data storage means for storing data related to the geographical location of each user and/or installation, and computational means for determining, in response to a service action request from a requesting user or installation, the geographically closest user having the required level of competence to carry out the requested service action and to issue an authorization.

The service network may be configured in various different ways using electronic networks or the internet to access and exchange information.

### BRIEF DESCRIPTION OF DRAWINGS

The features and advantages of the invention will be appreciated upon reference to the following drawings, in which:

FIG. 1 is a schematic view of a robotic milking machine;

FIG. 2 is an operational layout of a service network for robotic milking machines; and

FIG. 3 is an alternative operational layout of a service network for robotic milking machines.

### DETAILED DESCRIPTION

The following is a description of a practical application of the present invention in providing an improved service level for a milking robot, specifically an Astronaut™ milking robot as manufactured by Lely Industries N.V.. This embodiment of the invention is given by way of example only and it is to be understood that the principles as herein defined are equally applicable to methods of service and service networks associated with other technical installations.

A milking robot is a highly technical installation which may include a robotically controlled arm for placing the teat cups on to the cow's udder, laser guidance systems for guiding the arm, chemical analysis sensors for analyzing the milk produced for bacteria and viruses and computer hardware and software systems for controlling the operation of the various components and for interfacing with external systems. The system is designed to operate substantially without human intervention day and night as and when the cow (or other dairy animal) requires milking. A single robot may serve up to about 60 animals. If each animal chooses to be milked on average three times a day, the robot must perform 180 milkings during this period.

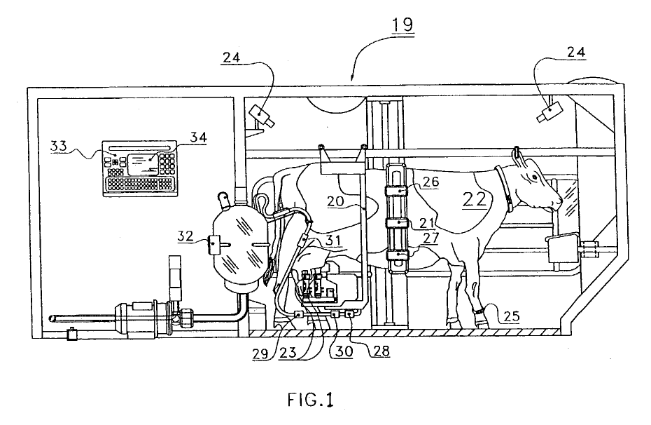

FIG. 1 shows a side view of an Astronaut™ milking box 19 with a cow 22 present therein. The milking box 19 is provided with a milking robot 20 with teat cups 23 which are automatically connected to the teats of the cow 22 by means of the milking robot 20. Near the front side of the milking box 19 there is further disposed a feeding trough to which concentrate may be supplied in metered quantities. For the purpose of controlling operation of the milking robot 20, various sensors and devices may be provided. These may include a yield meter 32 by which the milk yield is measured and a flow sensor 28 for measuring the flow pattern of the milk obtained during a milking run. The operation of the milking robot 20 and monitoring of measurement data is controlled by a processing device 33, which includes a computer having a memory and a screen 34. Other elements of the milking box and the robot are not shown in the figure for the sake of clarity.

Maintaining a constant fault free service is a major problem for the supplier of such milking robots. In the environment of the cowshed in which such devices are installed the whole installation is subjected to constant splattering. Above all else, the milking robot must maintain sterility and is subjected to a rigorous cleaning schedule of essential elements after each operation. Furthermore, many of the components frequently receive kicks and blows from unruly cows. In the case of breakdown, the milking robot must be up and running again as soon as possible and preferably within two hours. Since the milking robot is designed to operate without human intervention, existing milking robots employ substantial diagnostic and warning systems to provide indication to the herdsman or to a service center that a fault has occurred. It has been found however that although a fault may be reported quickly, providing a qualified service technician at the scene of the fault when the milking robot is located in a rural area is extremely problematic and can involve considerable time and expense.

For the Astronaut™ milking robot, Lely Enterprises as service provider has identified and selected a number of key service actions. These include:

Hardware:

A. check laser+change chain belt and/or laser flat cable

B. change MV15 valve for positioning the mother ship

C. change Bosch valve (30 series)/vacuum regulator (<=20-series)

D. change vacuum sensor (<=20 series)/air flow sensor (30-series)

E. change MV30 valve S-lina

F. change feed motor (<=20 series)/feed cylinder (30 series)

G. change other small broken/used parts as specified in the course

H. minor repairs on compressor and air dryer

Software:

I. X-Pert: start-up, communication settings, upgrade/overwrite version, check communication drivers

J. reset VCPC and make cold boot

K. test menu robot: check laser, milking system, cleaning system

L. reset CRS

These service actions have been selected on the basis that they are considered to be essential and commonly occurring actions, which it may be desirable to instruct users of the Astronaut™ to perform without requiring the attendance of a service engineer. They may be regarded as “first-aid” actions. The list is given as an example only and it is not necessary for the reader to understand the precise nature of the actions this is part of the training programme itself. Further details are provided in the Lely Operators' Maintenance and Service Certificate and its appendices, hereby incorporated by reference in their entirety. Clearly, other actions may also be included in the list as experience shows that these actions are desirable or as trained users advance in terms of competence. Equally, actions may be removed from the list if their infrequent occurrence no longer merits their inclusion or if their performance by trained users leads to undesirable complications.

According to a principle of the invention, users desiring to participate in the service scheme may attend training courses organized by trained service engineers or other suitable instructors, in which the necessary technical know-how to perform the selected actions is imparted. On successful completion of the course, a user may be authorized to perform some or all of the selected service actions. In this context, authorized is used in the sense that the user is considered competent to perform the action and that in doing so, any warranty on the milking robot will not be invalidated.

The service provider or in this case the supplier and distributor of Astronaut TM milking robots who is responsible for ensuring their continuing operation, maintains a record of the users. This record may include all the users in a given geographical area or may be limited only to those users who have actually participated in a training course. The record may be stored in terms of:

action data, listing all the actions which each user is authorized to perform;

competence data indicating for each action the level of competence achieved this may be simply the number of such actions performed or any other measure of competence taking into account such factors as unsuccessful performance of an action;

geographical data, giving the geographical location of the user in certain cases it may be more convenient to additionally or alternatively store the geographical location of the milking robot if this is located at a different location to the user.

Other data may also be stored such as availability data, language data (in the case of operation in a multilingual environment), billing and credit data and service contract data.

This record may be stored on any convenient storage means, preferably in electronic format. According to a preferred embodiment the storage means may be a database structure on an electronic computer. In this case, separate data modules may be present for storing the different fields of the database representing action data, competence data and geographical data. The actual physical form of the storage means is then dependent upon the hardware present on the computer. Floppy disks, optical disks, CD ROMS, hard disks, solid state memory such as EPROMS and any other form of suitable memory device may be used. Other data structures may also be employed. For instance, data could be stored in distributed mode, with each user's record being associated with and stored in a memory device or devices on the individual milking robots or on a home computer or other portable device such as a mobile phone, associated with each user. While electronic format of data is at present preferable, it is envisaged that other forms of storage using e.g. optical technology or other not yet developed alternatives could also be used without departing from the scope of the present invention. Furthermore, it is also considered that a paper or card based system may be used instead of or in addition to (as a backup) the above mentioned electronic system.

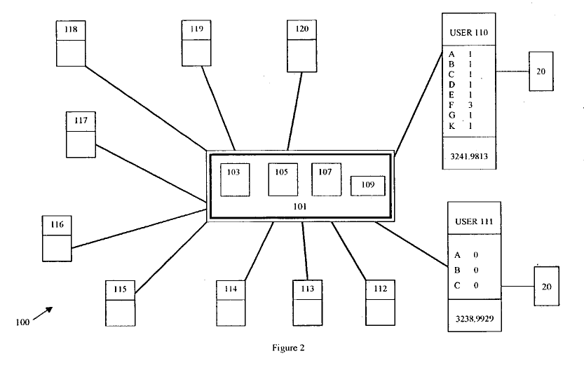

Operation of a first embodiment of the service network according to the present invention will now be described with reference to FIG. 2 which shows a service network 100 comprising a service provider 101 and a plurality of users 110 120 which are in this example all associated with a respective milking robot 20. The service provider 101 is provided with action data storage means 103, storing data for each user concerning the particular service actions which that user is trained to carry out; competence data storage means 105, storing data for each user concerning the level of competence which that user has in carrying out the service actions; geographical data storage means 107, storing data related to the geographical location of each user and/or technical installation; and computational means 109. In this example the computational means is preferably a computer or microprocessor configured to provide the necessary output according to a software program. Alternatively, and in its simplest form the computational means may be effectively omitted and the determination of the closest competent user may be simply made by the service provider by consulting a list of the available users in the knowledge of their respective locations. Although reference has been made to “geographically closest” user, it is understood that what is essential is the user who is closest in terms of arrival time. Thus local knowledge of the travel time may also be taken into account on determining the temporally closest user. The computational means may therefore also comprise navigational aids such a electronic navigation devices or standard maps.

Data storage means 103, 105, 107 may include floppy disks, optical disks, CD ROMS, hard disks, solid state memory such as EPROMS and any other form of suitable memory device. The data storage means 103, 105, 107 may also form part of a database structure on an electronic computer. In this case, separate data modules may be present for storing the different fields of the database representing action data, competence data and geographical data. The actual physical form of the storage means is then dependent upon the hardware present on the computer. While electronic format of data is at present preferable, it is envisaged that other forms of storage using e.g. optical technology or other not yet developed alternatives could also be used without departing from the scope of the present invention. Furthermore, it is also considered that use of a paper or card based system may be used instead of or in addition to (as a backup) the above mentioned electronic system.

User 110 is illustrated in detail in terms of the recorded data which is stored in the service network 100 in association with that user 110. In this example the user is recorded as being trained to carry out service actions A-D, F, G and K. A level of competence of 1 is indicated for each of the actions except for F, which is indicated at competence level 3. This indicates that user 110 has followed the training course and successfully completed training for service actions A-D, F, G and K. He has also successfully changed a feed motor (F) on two occasions. User 110 is also recorded to be at geographical location 3241.9813. This may be a grid reference location, an address, a GPS reference, a post or ZIP code or any other form of data, which adequately identifies the location of the user. User 110 is associated with a milking robot. Other similar data is stored for users 111-120.

Service network 100 also stores further data DAT related to other aspects of the user and the associated milking robot 20. This may include: manufacturer's serial data; historical data concerning the age and breakdown and service history for the milking robot 20; production history concerning the volume of milk produced; and may also include veterinary and feeding history concerning the herd. Clearly such data may be subject to data protection guidelines.

On experiencing a breakdown, milking robot 20 sends an alarm signal to user 110. This alarm signal indicates a service action C falling within the service actions for which user 110 is trained and competent. User 110 requests a service action authorization from the service provider 101 to carry out the repair. Computational means 109 determines, in response to the service action request from the requesting user 110, that the geographically closest user having the required level of competence to carry out the requested service action is the user 110. An authorization is issued and received by user 110. The repair is carried out successfully and on reporting back to the service provider the competence level of user 110 is increased to 2 for action C.

In this simple example, authorization request may be dispensed with on the basis that the authorization is already provided on completion of training. It is preferred however that feedback between the user and service provider occurs in order to maintain data on the occurrence rate for particular breakdowns and incidents.

A second user 111 also experiences a breakdown of the same type. User 111 has not attended the training course and has no service action training recorded. On requesting service, no authorization is given. Service provider 101 locates user 110 as being the geographically closest user to user 111 with the required competence. In this case, since user 110 has competence level 2, he is authorized to conduct repairs on other user's installations. User 110 indicates to the service provider 101 availability and willingness to provide the required service and travels to user 111 to conduct the repair. On successful completion, user 110 reports back and is upgraded to competence level 3 by the service provider. User 110 is also credited with a service fee according to a previously agreed rate. User 111 is debited with a service fee according to the conditions of the service contract between user 111 and service provider 101.

A third user 115 experiences a different breakdown. This breakdown requires a service action X, not included in the training course and requiring specialist technical support. Since none of the users 110-120 are competent for providing service action X, service provider 101 dispatches a skilled technician directly to render the necessary service.

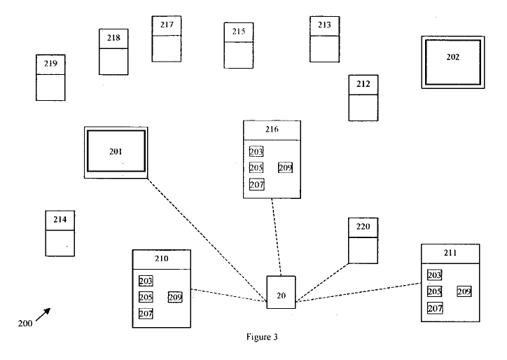

An alternative arrangement is illustrated in FIG. 3 which shows a distributed service network 200. The distributed network 200 includes a number of service providers 201, 202. A number of users 210 220 are also indicated, each being provided with action data storage means 203; competence data storage means 205; geographical data storage means 207; and computational means 209. In this example the computational means is preferably a personal computer at the users farmhouse or dairy or the microprocessor 33 within the milking robot itself. Alternatively it may be implemented as software installed on a mobile phone or other mobile device.

A milking robot 20 detects a faulty vacuum sensor and requests a service action D. This action is received by nearest user 210 which, as usually happens, is the user associated with that milking robot. User 210 is not competent to perform the service action D and computational means 209 associated with user 210 does not issue an authorization. Milking robot then interrogates the next closest user 211 who is also not competent to intervene, having only competence level 1 and thus only being authorized to repair his own installation. Interrogation continues until a user 216 is found who is both competent and available. This user 216 attends to the repair and is updated in competence and credited with a service fee as in the previous example.

In the present context, although users have been referred to as users of the system or herdsmen, this term may equally include other parties including, milk tanker drivers, vets, retired farmers and others who may have an interest in joining the service scheme whereby they may become net suppliers of service. In this example, the distinction has been made between service providers and other “users”, whereby service providers are considered to be service agents with full competence and/or responsibility for all possible service actions, while users have limited or no competence and need not be responsible for providing service actions to other users.

Advantageously, by providing the users with mobile devices, the actual location of the users can be constantly determined via electronic interrogation, GPS location or via other commercially available systems using e.g. Bluetooth™ technology.

A particularly advantageous embodiment of the present invention uses the service network to provide feedback and parts stock control for the serviced items. Participating users who have followed the training are issued with a specialist extended toolkit adapted to their particular model of milking robot. Its contents are based on practical experiences from service providers and users, including the parts that are needed for both ‘simple’ and ‘urgent’ repairs such as laser chain belt and flat cable. The extended tool kit consists of approx. 50 different parts, a list of which is given in Appendix 1 hereto.

On performance of a service action involving the use of a particular part from the toolbox, a report is drafted and provided to the service provider, including part number, serial no, failure description etc. In this way, the service provider can keep effective track of all failures that have occurred. This report may be provided in electronic form or may be a paper form, collected by the service provider together with collection and replacement of the damaged part.

While the invention has been described by reference to the embodiments discussed above, it will be recognized that these embodiments are susceptible to various modifications and alternative forms well known to those of skill in the art. For example, the service network may be modified to allow service by the user associated with the milk robot and by the service provider but not by other users. Alternatively, the service network and the method of providing service may be adapted to other suitable technical installations which require urgent and specialist maintenance.

Suitable technical installations are ones for which a group of “first-aid” service actions can be identified and where a group of users can be defined and trained to a sufficient level to adequately perform these service actions.

Many modifications in addition to those described above may be made to the structures and techniques described herein without departing from the spirit and scope of the invention. Accordingly, although specific embodiments have been described, these are examples only and are not limiting upon the scope of the invention.

1. A method of providing service for a serviced item, comprising the steps of:
identifying a first group of service actions;
identifying a second group of service actions;
training a user to perform the second group of service actions; and
authorizing a user to perform a service action only if the service action falls in the second group of service actions.

2. The method according to claim 1, further comprising providing service by an authorized service provider if the service action falls in the first group of service actions.

3. The method according to claim 2, comprising the step of providing a service contract and wherein the service contract is partially or wholly invalidated by performance of a service action that is not authorized.

4. The method according to claim 3, wherein the serviced item is a milking machine and the second group of service actions comprise routine maintenance, and minor repairs.

5. The method according to claim 4, further comprising providing the user with a toolbox containing necessary tools for performing the second group of service actions.

6. The method according to claim 4, whereby the step of training a user takes place in a training course determined by the service provider and the step of authorizing a user takes place on successfully completing the training course.

7. The method according to claim 1, further comprising monitoring the occurrence of service actions and updating the first and second groups of service actions on the basis of the monitoring.

8. The method according to claim 7, further comprising maintaining a statistical record of the occurrence of different individual service actions and updating the first and second groups of service actions on the basis of the statistical record.

9. The method according to claim 1, further comprising monitoring the occurrence of service actions and maintaining a record of the state of service of the serviced items on the basis of data received during the monitoring.

10. The method according to claim 1, further comprising monitoring the occurrence of service actions and maintaining a record of the down time of the serviced items on the basis of data received during the monitoring.

11. The method according to claim 1, further comprising:
training a second user to perform a third group of service actions including service actions from the first group and the second group;
authorizing the second user to perform the service action for the first user if the service action falls in the third group of service actions.

12. The method according to claim 11, further comprising determining a competence level for each service action as performed by each user and updating the competence level in response to completed service actions.

13. A method of reducing the cost of service of a serviced item, comprising:
providing a service contract between a service provider and a user of the serviced item, and covering at least a first group of service actions;
identifying a second group of service actions;
training the user to recognize and perform service actions from the second group of service actions; and
authorizing the user to perform a service action only if the service action falls in the second group of service actions.

14. The method according to claim 13, whereby the step of training the user takes place in a training course provided by the service provider.

15. The method according to claim 13, further comprising providing service by the service provider if the service action falls in the first group of service actions.

16. The method according to claim 15, wherein the service contract is partially or wholly invalidated by performance of a service action that is not authorized.

17. The method according to claim 16, wherein the serviced item is a milking machine and the second group of service actions comprise routine maintenance and minor repairs.

18. The method according to claim 17, further comprising providing the user with a toolbox containing necessary tools for performing the second group of service actions.

19. A service network comprising a service provider, a plurality of installations and a plurality of users, at least some of the users being trained to carry out different service actions on the installations, the service network comprising:
action data storage means for storing data for each user concerning the particular service actions which that user is trained to carry out;
competence data storage means for storing data for each user concerning the level of competence which that user has in carrying out the service actions;
geographical data storage means for storing data related to the geographical location of each user and/or installation; and
computational means for determining, in response to a service action request from a requesting user or installation, the closest user having the required level of competence to carry out the requested service action and to issue an authorization.

20. The service network according to claim 19, wherein if the closest user is the requesting user, the requesting user is authorized to carry out the requested service action.

21. The service network according to claim 19, wherein the service network further comprises availability data storage means for storing data for each user concerning the availability of that user for carrying out the service actions.

22. The service network according to claim 19, wherein the installations are electronically linked to the service network to provide the service action request.

23. The service network according to claim 19, wherein the action data storage means, competence data storage means and geographical data storage means are provided as computer memory devices.

24. The service network according to claim 23, wherein a plurality of users or installations are provided with computers for storing at least a portion of the action data, competence data and geographical data.

25. The service network according to claim 19, wherein the computational means is centrally located at the service provider.

26. The service network according to claim 19, wherein the computational means is located at or associated with some or all of the users or installations.

27. The service network according to claim 19, wherein the plurality of users include authorized service personnel associated with the service provider.
